(19) United States
(12) Patent Application Publication
(10) Pub. No.: US 2012/0080959 A1
(43) Pub. Date: Apr. 5, 2012

(54) Linear vibrator

(75) Inventors: Hwa Young Oh, Seoul (KR); Kwang Hyung Lee, Suwon (KR)

(73) Assignee: SAMSUNG ELECTRO-MECHANICS CO., LTD., Suwon (KR)

(21) Appl. No.: 13/064,783

(22) Filed: Apr. 14, 2011

(30) Foreign Application Priority Data
Oct. 4, 2010 (KR) 10-2010-0096364

(51) Int. Cl. H02K 33/00

(52) U.S. Cl. 310/25

(57) ABSTRACT

There is provided a linear vibrator according to an exemplary embodiment of the present invention, including: a fixing unit providing an internal space having a predetermined size; a plurality of magnets disposed in the internal space of the fixing unit and positioned to have the same poles face each other so as to generate magnetic force; a vibration unit disposed to face the magnets and including a coil generating electromagnetic force through interaction with the magnets and a vibrating mass body; and an elastic member joined to the fixing unit and the vibration unit to provide elastic force.

### CROSS-REFERENCE TO RELATED APPLICATIONS

This application claims the priority of Korean Patent Application No. 10-2010-0096364 filed on Oct. 4, 2010, in the Korean Intellectual Property Office, the disclosure of which is incorporated herein by reference.

### BACKGROUND OF THE INVENTION

1. Field of the Invention

The present invention relates to a linear vibrator, and more particularly, to a linear vibrator that improves electromagnetic force and vibration force by adopting a magnet structure capable of increasing magnetic efficiency.

2. Description of the Related Art

In recent years, the launching of personal portable terminals having large LCD screens to the market has rapidly increased to facilitate user convenience, and, as a result, a touch screen type screen has largely been adopted and a vibration motor for generating vibration in a touch has been used.

The vibration motor, which is a component that converts electrical energy into mechanical vibrations by using a generation principle of electromagnetic force, has been mounted on the personal portable terminal and used for silent incoming call informing.

In the related art, a method of acquiring mechanical vibrations by generating rotation force to rotate a rotating part having unbalanced mass was used and the rotation force is generated by using a method of generating mechanical vibrations by a rectifying action through a contact between a brush and a commutator.

However, in such a brush type structure using the commutator the brush passes through a gap between segments of the commutator, causing mechanical friction and electrical sparking and generating foreign objects when the motor rotates, such that the life-span of the motor is shortened.

Further, since it takes a time to reach a target vibration quantity due to a rotational inertia at the time of applying voltage to the motor, it is difficult to implement appropriate vibration in a touch screen.

A linear vibrator is generally used in order to overcome demerits in the life-span and the responsiveness of the motor and implement a vibration function of the touch screen.

The linear vibrator does not use a rotational principle of the motor, and oscillation is generated by periodically generating electromagnetic force acquired through a spring installed therein and a mass body hung on the spring according to an oscillation frequency to generate vibration.

However, the linear vibrator designed to vibrate in a vertical direction is limited in the overall thickness thereof because the mass body installed therein moves while ensuring vertical displacement to generate vibration.

By the way, since a personal portable terminal adopting the linear vibrator is limited in terms of the space in which the linear vibrator can be mounted, the thickness of the linear vibrator cannot be increased without limitation in order to ensure the vibration quantity of the linear vibrator.

Accordingly, a research into generating more stable linear vibration while miniaturizing and thinning the linear vibrator is urgently needed.

### SUMMARY OF THE INVENTION

An aspect of the present invention provides a linear vibrator capable of ensuring a vibration quantity while maintaining the miniaturizing and thinning thereof by modifying the structure of a coil and a magnet that generate electromagnetic force for vibration.

According to an aspect of the present invention, there is provided a linear vibrator including: a fixing unit providing an internal space having a predetermined size; a plurality of magnets disposed in the internal space of the fixing unit and positioned to have the same poles face each other so as to generate magnetic force; a vibration unit disposed to face the magnets and including a coil generating electromagnetic force through interaction with the magnets and a vibrating mass body; and an elastic member joined to the fixing unit and the vibration unit to provide elastic force.

The fixing unit may include a case providing internal space and having an opened lower part and a bracket sealing the internal space of the case and the magnet may be joined to each of one surface of the case and one surface of the bracket.

The linear vibrator may further include a plate formed on one surface of at least one of the magnets and allow magnetic flux that flows on the magnet through the coil to smoothly flow.

The upper surface and the lower surface of the plate may be joined to surfaces of the magnets, respectively.

The fixing unit may include a case providing internal space and having an opened lower part and a bracket sealing the internal space of the case and the magnet may be joined to each of one surface of the case and one surface of the bracket.

The plate may be made of a magnetic material.

The vibration unit may include a holder fixing and supporting the coil and the mass body.

The holder may be constituted by a cylindrical vertical portion which contacts one surface of each of the coil and the mass body and a horizontal portion which extends inwardly or outwardly in a radial direction on the end of the vertical portion to fix and support the other surface of the coil or the mass body.

The vertical portion may be higher than the lower surfaces of the coil and the mass body to form space between the coil and the mass body and an adhesive may be filled in the space.

The coil may house a part of an outer peripheral surface of the magnet and a central axis of the coil may be the same as a magnetization direction of the magnet.

The linear vibrator may further include a damper joined to one surface of the vibration unit to prevent a contact between the vibration unit and the fixing unit due to vibration of the vibration unit.

The linear vibrator may further include a printed circuit board electrically connected with the coil to provide current to the coil and including a power connection terminal formed at one end thereof.

The printed circuit board may include a movement piece that is joined with the coil and vibrates in conjunction with the vibration unit, a fixation piece that includes the power connection terminal and is joined to the fixing unit, and a connection piece that connects the movement piece and the fixation piece with each other and is flexible.

The linear vibrator may further include a damper joined to one surface of the printed circuit board to prevent contact between the vibration unit and the fixing unit due to vibration of the vibration unit.

The coil may include a coil drawing line that extends to the fixing unit for electrical connection with the power connection terminal joined to the fixing unit to connect the power connection terminal in order to apply power from the outside.

The linear vibrator may further include a magnetic fluid disposed on an outer peripheral surface of the magnet to facilitate vertical movement of the vibration unit.

At least one introduction hole through which a laser beam for joining the elastic member and the vibration unit to each other passes may be formed on one surface of the fixing unit to allow the magnetic fluid to be disposed on the outer peripheral surface of the magnet.

The elastic member may be at least one of a coil spring and a plate spring.

According to another aspect of the present invention, there is provided a linear vibrator including: a fixing unit including a case providing internal space and having an opened lower part and a bracket sealing the internal space of the case; first and second magnets disposed in the internal space of the fixing unit and positioned to have the same poles face each other so as to generate magnetic force and joined to one surface of the case and one surface of the bracket, respectively; a vibration unit including coils disposed to face the first and second magnets and generating electromagnetic force through interaction with the first and second magnets and a holder fixing and supporting a vibrating mass body; and an elastic member joined to the fixing unit and the vibration unit to provide elastic force.

The linear vibrator may further include a plate formed on one surface of at least one of the first and second magnets and allow magnetic flux that flows on the first and second magnets through the coil to smoothly flow.

The linear vibrator may further include a magnetic fluid disposed on an outer peripheral surface of the magnet to facilitate vertical movement of the vibration unit.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic exploded view illustrating a linear vibrator according to a first exemplary embodiment of the present invention;

FIG. 2 is a schematic cutaway perspective view illustrating the linear vibrator according to the first exemplary embodiment of the present invention;

FIG. 3 is a schematic cross-sectional view illustrating the linear vibrator according to the first exemplary embodiment of the present invention;

FIG. 4 is a schematic cross-sectional view illustrating a linear vibrator according to a second exemplary embodiment of the present invention;

FIG. 5 is a schematic cross-sectional view illustrating a linear vibrator according to a third exemplary embodiment of the present invention;

FIG. 6 is a schematic cross-sectional view illustrating a linear vibrator according to a fourth exemplary embodiment of the present invention;

FIG. 7 is a schematic cross-sectional view illustrating a linear vibrator according to a fifth exemplary embodiment of the present invention;

FIG. 8 is a schematic perspective view illustrating a printed circuit board provided in a linear vibrator according to the present invention;

FIG. 9 is a schematic perspective view illustrating a state in which a coil and a damper are joined to the printed circuit board provided in the linear vibrator according to the present invention;

FIG. 10 is a schematic cross-sectional view illustrating a linear vibrator according to a sixth exemplary embodiment of the present invention; and

FIG. 11 is a schematic cross-sectional view illustrating a linear vibrator according to a seventh exemplary embodiment of the present invention.

### DETAILED DESCRIPTION OF THE PREFERRED EMBODIMENT

Hereinafter, detailed exemplary embodiments of the present invention will be described with reference to the accompanying drawings. However, the spirit of the present invention is not limited to the exemplary embodiments and other exemplary embodiments included in other retrogressive inventions or within the spirit of the present invention can be easily proposed by those skilled in the art through adding, modifying, and deleting other components without departing from the same spirit. However, it will be included in the range of the spirit of the present invention.

Further, like reference numerals refer to like elements having the same function within the same spirit shown in the drawings of the exemplary embodiments.

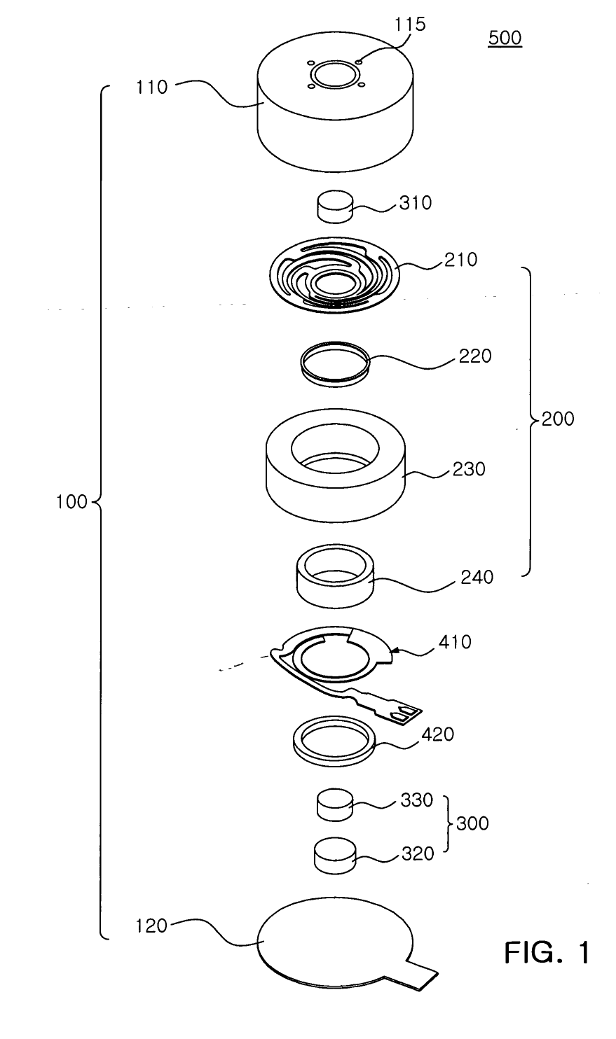

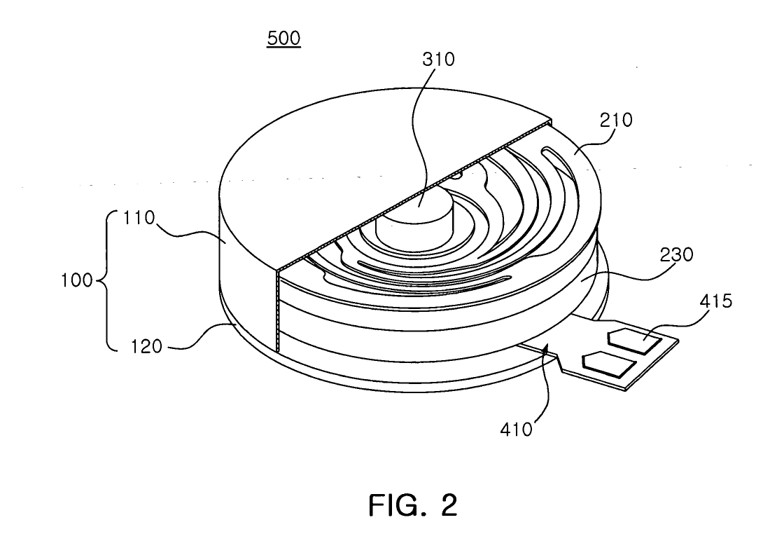

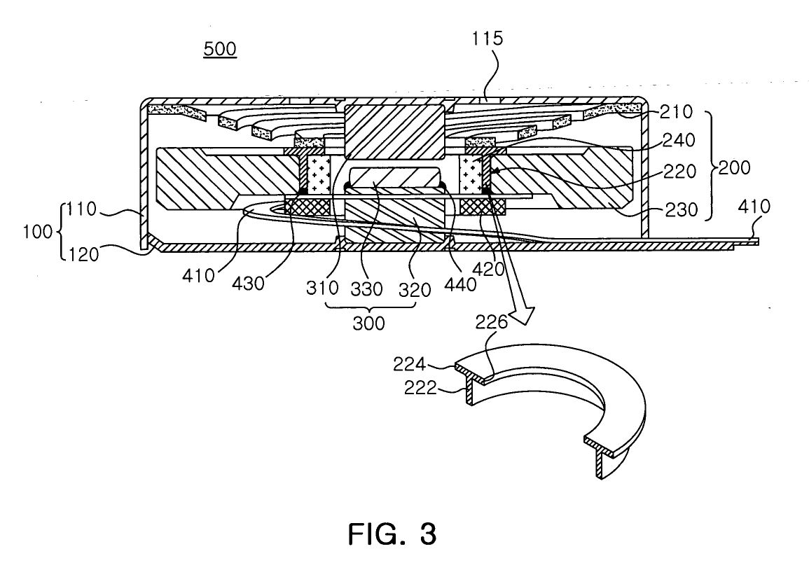

FIG. 1 is a schematic exploded view illustrating a linear vibrator according to a first exemplary embodiment of the present invention, FIG. 2 is a schematic cutaway perspective view illustrating the linear vibrator according to the first exemplary embodiment of the present invention, and FIG. 3 is a schematic cross-sectional view illustrating the linear vibrator according to the first exemplary embodiment of the present invention.

Referring to FIGS. 1 to 3, the linear vibrator 500 according to the first exemplary embodiment of the present invention may include a fixing unit 100, a magnetic field unit 300, a vibration unit 200, and an elastic member 210.

The fixing unit 100 is provided with an internal space having a predetermined size. A case 110 having an opened lower part and the internal space of the case 110, that is, the lower part of the case 110 opened downward may be sealed by a bracket 120.

Herein, a space capable of housing the magnetic field unit 300 and the vibration unit 200 to be described below is formed by the case 110 and the bracket 120, and the case 110 and the bracket 120 may be integrally formed.

Further, at least one introduction hole 115 may be formed on the top of the case 110 in order to place a magnetic fluid 440 to be described below on outer peripheral surfaces of first and second magnets 310 and 320, and the magnetic fluid 440 may be easily applied through the introduction hole 115.

Further, the introduction hole 115 may be a through-hole through which a laser beam passes, which is required when the elastic member 210 to be described below and a holder 220 of the vibration unit 200 are joined to each other, that is, when the elastic member 210 and the holder 220 are joined to each other by welding.

The magnetic field unit 300 may be formed by the magnets 310 and 320 and a plate 330 and the magnets 310 and 320 may be constituted by the first magnet 310 and the second magnet 320.

The first magnet 310 may contact an upper internal sealing surface of the case 110 and the second magnet 320 may be joined to the top of the bracket 120.

The first and second magnets 310 and 320 are cylindrical permanent magnets that generate magnetic force having a predetermined intensity while upper and lower parts thereof are vertically magnetized to different poles to generate a magnetic field. The first and second magnets 310 and 320 may be bonded through a bonding agent to be fixed to the upper internal sealing surface of the case 110 and the upper surface of the bracket 120.

The first and second magnets 310 and 320 may be positioned so that the same poles thereof face each other in order to generate the magnetic force and spaced apart from each other.

Magnetic force lines which exist between the first and second magnets 310 and 320 are dispersed outwardly in a radial direction by the first and second magnets 310 and 320 disposed to face each other at the poles thereof to increase magnetic efficiency. Particularly, when the magnetic force is concentrated on a portion at which a coil 240 to be described below as being positioned on outer peripheries of the first and second magnets 310 and 320 fluxes to consume the same current in the same volume, the first and second magnets 310 and 320 may implement larger electromagnetic force than a single magnet and implement a larger vibration quantity.

However, the magnets 310 and 320 are not limited to be formed by the first and second magnets 310 and 320 and if the magnets 310 and 320 may be positioned to have the same poles face each other, the magnet may be formed by two or more magnets.

Herein, the plate 330 is joined to the upper surface which is one surface of the second magnet 320 so that magnetic flux which flows to the second magnet 320 through the coil 240 generating the electromagnetic force is smoothly formed by interaction with the second magnet 320.

The plate 330 may be made of a magnetic material to smoothly apply the magnetic fluid 440 to be described below.

That is, the magnetic fluid 440 may be applied between the outer peripheral surfaces of the second magnets 320 and the plate 330 and the coil 240 and the magnetic fluid 440 may serve to prevent minor vibrations of the vibration unit 200 to be described below.

The magnetic fluid 440 may be disposed in a gap between the second magnet 320 and the coil 240 to facilitate vertical movement of the vibration unit 200 and the magnetic fluid 440 may prevent minor vibration when the vibration unit 200 wobbles horizontally or vertically by an external shock.

When the magnetic fluid 440, which is a material having a property to concentrate on the magnetic flux of the second magnet 320, is applied to one surface of the second magnet 320, the magnetic fluid 440 concentrates on a magnetic flux generation point of the second magnet 320 to form a single ring shape.

Herein, in the magnetic fluid 440, the magnetic fluid 440 magnetic powder is dispersed to liquid in a colloidal shape and a surfactant is added to prevent the magnetic powder from being deposited and condensed by gravity or the magnetic field. For example, examples of the magnetic fluid 440 include a fluid in which triiron tetraoxide or an iron-cobalt alloy molecule is dispersed into oil or water and recently include cobalt is dispersed into toluene.

The magnetic powder is ultra-fine particle powder and it performs Brownian motion specific to ultra-fine particles to maintain the concentration of magnetic powder particles in the fluid to be constant, even though an external magnetic field, the gravity, or centrifugal force is applied.

Further, the magnetic fluid 440 fills a gap between the outer surfaces of the magnets 310 and 320 and the inner surface of a hollow of the coil 240 to allow the vibration unit 200 to smoothly vibrate or side.

The vibration unit 200 may include the coil 240, the holder 220, and the mass body 230 and the vibration unit 200 may vibrate vertically through the elastic member 210 to be described below.

The coil 240 is disposed to face the first and second magnets 310 and 320 and a part of the first or second magnet 310 or 320 including one surface may be inserted into the space in which the coil 240 is formed.

Further, the coil 240 may be joined to the inner surface of a hollow of the holder 220 and when current is applied to the coil 240 with a predetermined frequency, the magnetic field may be induced in the vicinity of the coil 240.

At this time, when the electromagnetic force is applied through the coil 240, the direction of the magnetic flux passing through the coil 240 in the magnets 310 and 320 is horizontally formed and the magnetic field generated by the coil 240 is vertically formed, such that the vibration unit 200 vibrates vertically. As a result, the direction of the magnetic flux of the magnets 310 and 320 is vertical to the vibration direction of the vibration unit 200.

That is, when the electromagnetic force is induced with a specific vibration frequency of the vibration unit 200, the maximum vibration quantity may be acquired through resonant vibration and the specific vibration frequency of the vibration unit 200 is influenced by the mass of the vibration unit 200 and an elastic coefficient of the elastic member 210.

Meanwhile, a printed circuit board 410 may be joined to the lower surface of the coil 240 in order to provide current to the coil 240 and a power connection terminal 415 may be formed on one end of the printed circuit board 410.

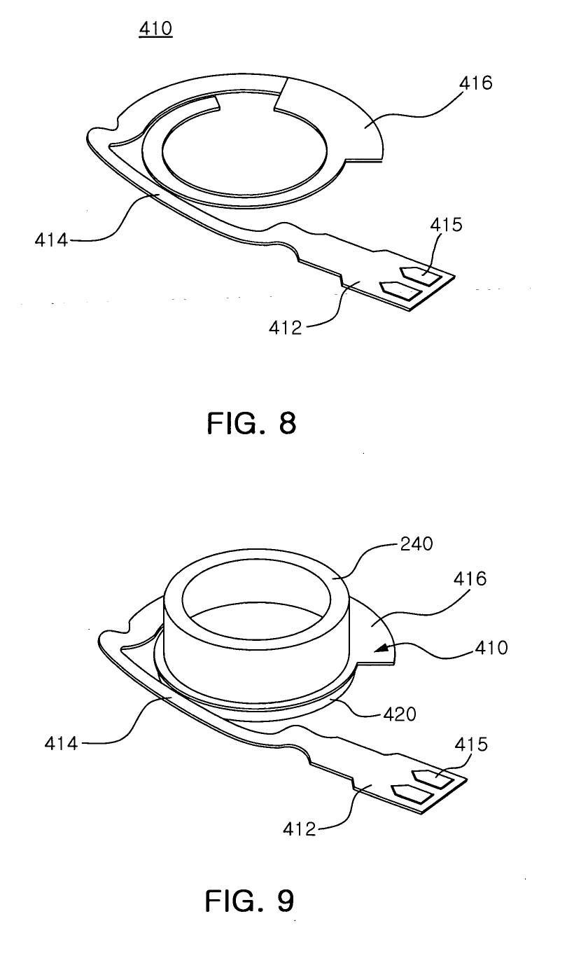

Further, a damper 420 may be joined to the lower surface of the printed circuit board 410 to prevent the vibration unit 200 and the fixing unit 100 from contacting each other by vibration of the vibration unit 200 and the damper 420 and the printed circuit board 410 will be described in detail with reference to FIGS. 8 and 9.

The holder 220 may fix and support the mass body 230 that is joined to the outer peripheral surface of the coil 240 and vibrates and may be formed by a hollow cylinder of which the upper part and the lower part are opened.

In detail, the holder 220 may be constituted by a cylindrical vertical portion 222 which contacts one surface of each of the coil 240 and the mass body 230 and outer and inner horizontal portions 224 and 226 that extends to radial outer and inner parts on the end of the vertical portion 222 to support the other surface of each of the coil 240 and the mass body 230.

The outer peripheral surface of the vertical portion 222 and the lower surface of the outer horizontal portion 224 contact the mass body 230 to fix and support the mass body 230 and the inner peripheral surface of the vertical portion 222 and the lower surface of the inner horizontal portion 226 may fix and support the coil 240.

Further, the holder 220 may be made of iron and the holder 220 is made of the same material as the elastic member 210 to be easily and firmly joined to the elastic member 210.

However, the materials of the holder 220 and the elastic member 210 are not limited to iron and if the holder 220 and the elastic member 210 are easily and firmly joined to each other, any material may be used.

Further, the vertical portion 222 of the holder 220 may be higher than the lower surfaces of the coil 240 and the mass body 230 so that space is formed between the coil 240 and the mass body 230 and an adhesive 430 is charged in the space to more firmly join the coil 240 and the mass body 230 to each other.

In the case where the mass body 230, which is a vibration body that vibrates vertically by being joined to the outer surface of the vertical portion 222 of the holder 220 and the lower surface of the outer horizontal portion 224, vibrates vertically, the mass body 230 may have an outer diameter smaller than an inner diameter of the inner surface of the case 110 to vibrate without contact in the fixing unit 100.

As a result, a gap having a predetermined size may be formed between the inner surface of the case 110 and the outer surface of the mass body 230.

The mass body 230 is preferably made of a nonmagnetic or paramagnetic material which is not influenced by magnetic force generated from the first and second magnets 310 and 320.

Accordingly, the mass body 230 is preferably made of a material such as tungsten having a specific gravity heavier than iron to maximize the vibration quantity by a resonance frequency through increasing the mass of the vibration unit 200 within the same volume.

However, the material of the mass body 230 is not limited to tungsten and may be made of various materials according to a designer's intention.

Herein, the mass of the mass body 230 may be added to and subtracted from space into which a sub mass body may be additionally inserted in order to compensate the specific vibration frequency of the linear vibrator 500.

The elastic member 210 provides elastic force by being joined to the holder 220 and the case 110 as described above. The specific vibration frequency of the vibration unit 200 is influenced by the elastic coefficient of the elastic member 210.

Herein, the elastic member 210 may be any one of a coil spring or a plate spring, but is not limited thereto and if the elastic member 210 is a member providing elastic force, the elastic member 210 is not limited.

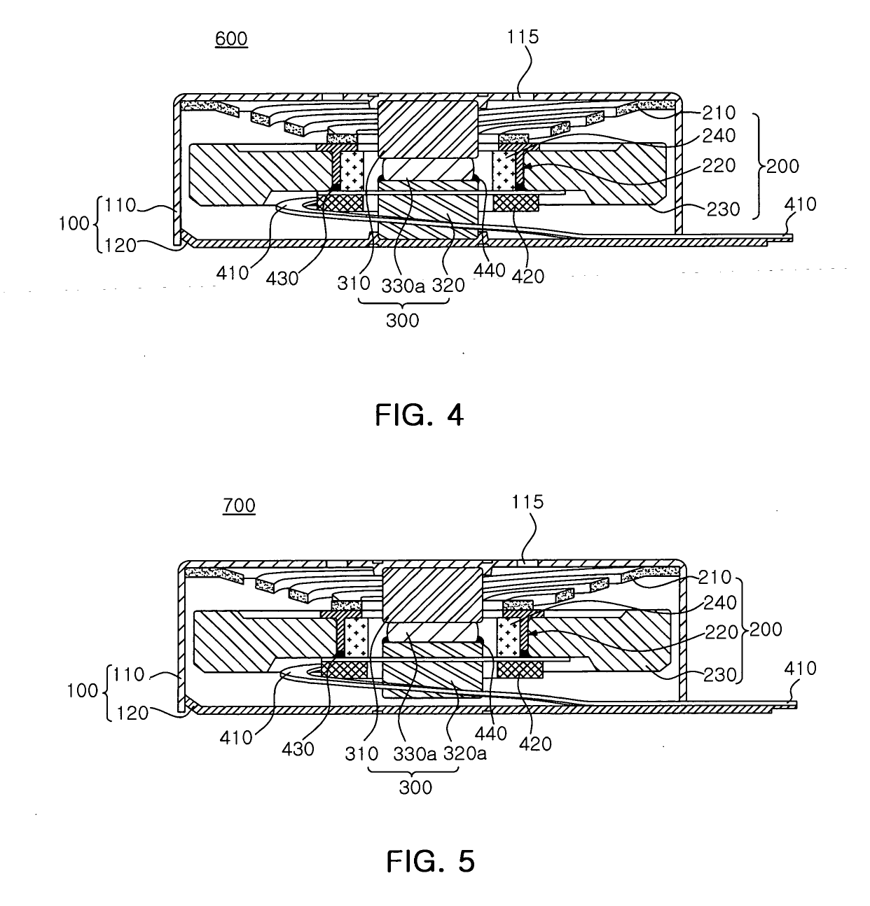

FIG. 4 is a schematic cross-sectional view illustrating a linear vibrator according to a second exemplary embodiment of the present invention.

Referring to FIG. 4, since the linear vibrator 600 according to the second exemplary embodiment of the present invention have the same configuration and effect as the first exemplary embodiment of the present invention except for the first and second magnets 310 and 320 and a plate 330a, a description of components other than the first and second magnets 310 and 320 and the plate 330a will be omitted.

The plate 330a is positioned between the first and second magnets 310 and 320 and the upper surface and the lower surface of the plate 330a may be joined to one surface of the first magnet 310 and one surface of the second magnet 320, respectively.

Herein, the other surfaces of the first and second magnets 310 and 320 may be joined to one surface of the case 110 and one surface of the bracket 120, respectively, as a result, the first and second magnets 310 and 320 and the plate 330a are joined to each other to serve as a single member.

FIG. 5 is a schematic cross-sectional view illustrating a linear vibrator according to a third exemplary embodiment of the present invention.

Referring to FIG. 5, since the linear vibrator 700 according to the third exemplary embodiment of the present invention has the same configuration and effect as the second exemplary embodiment except for the placement of a second magnet 320a, a description of components other than the second magnet 320a will be omitted.

The plate 330a may be joined to one surface of each of the first and second magnets and the other surface of the first magnet 310 may be joined to the internal sealing surface of the case 110.

However, the other surface of the second magnet 320a is positioned in an internal space provided by the case 110 and may be spaced apart from the upper surface of the bracket 120.

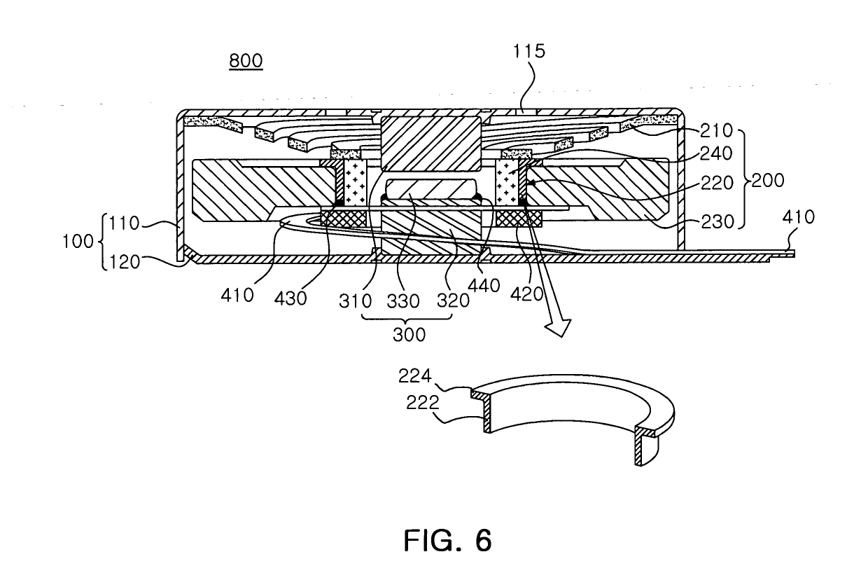

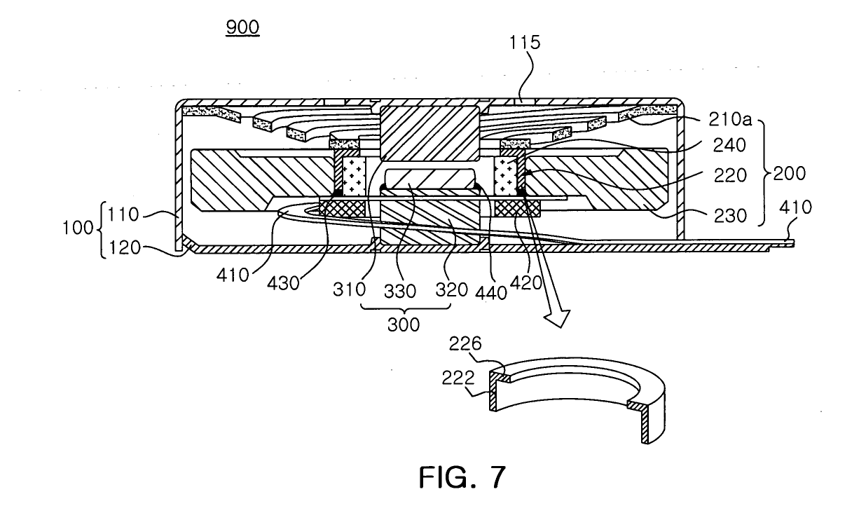

FIG. 6 is a schematic cross-sectional view illustrating a linear vibrator according to a fourth exemplary embodiment of the present invention and FIG. 7 is a schematic cross-sectional view illustrating a linear vibrator according to a fifth exemplary embodiment of the present invention.

Referring to FIGS. 6 and 7, the linear vibrators 800 and 900 according to the fourth and fifth exemplary embodiments of the present invention have the same configuration and effect as the first exemplary embodiment except for the structure of the holder 220, a description of components other than the holder 220 will be omitted.

The holder 220 shown in FIG. 6 may fix and support the mass body 230 that is joined to the outer peripheral surface of the coil 240 and vibrates and is formed by a hollow cylinder of which the upper part and the lower part are opened.

In detail, the holder 220 may be constituted by a cylindrical vertical portion 222 that contacts one surface of each of the coil 240 and the mass body 230 and an outer horizontal portion 224 that extends outwardly in a radial direction from the end of the vertical portion 222 to support the mass body.

Accordingly, the elastic member 210 may provide elastic force in contact with both the upper surfaces of the outer horizontal portion 224 and the coil 240.

The holder 220 shown in FIG. 7 may be constituted by a cylindrical vertical portion 222 that contacts one surface of each of the coil 240 and the mass body 230 and an inner horizontal portion 226 that extends inwardly in a radial direction from the end of the vertical portion 222 to support the coil 240.

FIG. 8 is a schematic perspective view illustrating a printed circuit board provided in a linear vibrator according to the present invention and FIG. 9 is a schematic perspective view illustrating a state in which a coil and a damper are joined to the printed circuit board provided in the linear vibrator according to the present invention.

Referring to FIGS. 8 and 9, the printed circuit board 410 provided to the linear vibrators 500, 600, 700, 800, 900, 1000, and 1100 according to the exemplary embodiments of the present invention may include a movement piece 416, a fixation piece 412, and a connection piece 414.

The movement piece 416 vibrates in conjunction with the vibration unit 200 and the lower surface of the coil 240 may be joined in contact with the upper surface of the movement piece 416.

A pattern for transferring an electrical signal having a predetermined frequency, which is applied through a power connection terminal 415 formed at the fixation piece 412 to the coil 240 is formed on the upper surface of the movement piece 416 to be electrically connected with the lower surface of the coil 240.

Herein, the fixation piece 412 is fixed to a bracket 120 and the connection piece 414 connecting the fixation piece 412 and the movement piece 416 to each other may be provided - in order to vibrate the movement piece 416.

The connection piece 414 is connected from one end of the fixation piece 412 while rotating in a circumferential direction of the movement piece 416 with a predetermined gap from the edge of the movement piece 416 to vibrate the movement piece 416 vertically.

Further, a damper 420 may be provided on the lower surface of the movement piece 416 to prevent the vibration unit 200 and the bracket 120 which is the fixing unit 100 from contacting each other by vibration of the vibration unit 200.

The damper 420 may be made of an elastic material to thereby prevent a contact by linear movement of the vibration unit 200 and may prevent touch noise from being generated when the vibration unit 200 contacts the bracket 120 by excessive vibration of the vibration unit 200 and prevent abrasion of the vibration unit 200.

Herein, the damper 420 may be made of various materials such as rubber, cork, propylene, phorone, and the like that can absorb a shock in order to absorb an external shock where the external shock is applied.

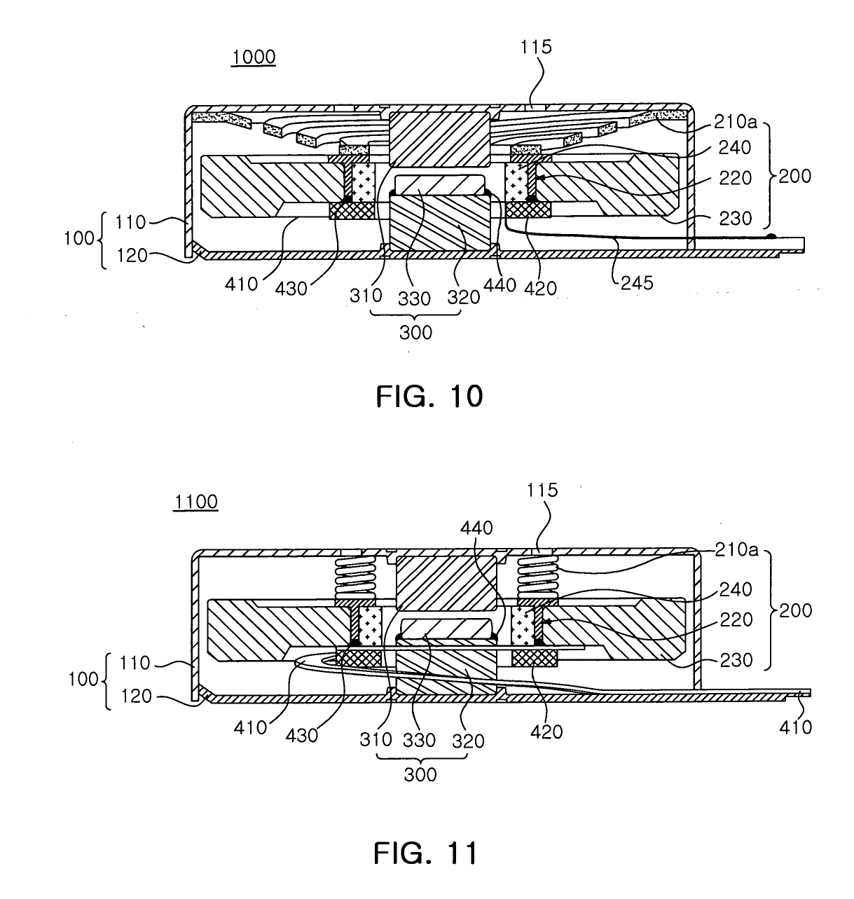

FIG. 10 is a schematic cross-sectional view illustrating a linear vibrator according to a sixth exemplary embodiment of the present invention and FIG. 11 is a schematic cross-sectional view illustrating a linear vibrator according to a seventh exemplary embodiment of the present invention.

Referring to FIG. 10, since the linear vibrator 1000 according to the sixth exemplary embodiment of the present invention has the same configuration and effect as the first exemplary embodiment except for a coil drawing line 245, a description of components other than the coil drawing line 245 will be omitted.

The coil drawing line 245 extends from one end of the coil 240 to be joined to a power connection terminal 415 formed in a bracket 120 and is preferably joined to the power connection terminal by soldering. However, the joining method is not limited to soldering and all joining method capable of performing electrical connection may be used.

Further, electrical connection may be implemented by using the above-mentioned elastic member 210 in addition to the method of electrically connecting the power connection terminal 415 by extending the coil drawing line 245.

That is, the method of connecting the power connection terminal 415 through the elastic member 210 and a fixing unit 100 by connecting one end of the coil 240 and the elastic member 210 with each other may be used.

Herein, a damper 420 may be directly joined to the lower surface of the coil 240 and the damper 420 may prevent touch noise from being generated when a vibration unit 200 contacts a bracket 120.

Referring to FIG. 11, since the linear vibrator 1100 according to the seventh exemplary embodiment of the present invention has the same configuration and effect as the first exemplary embodiment except for a coil spring 210a, a description of components other than the coil spring 210a will be omitted.

The coil spring 210a may be used as an elastic member 210a for transferring vibration of a vibration unit 200 and the coil spring 210a may be joined to a holder 220 and inner and outer horizontal portions 224 and 226.

In the exemplary embodiments, the first and second magnets 310, 320, and 320a, the plates 330 and 330a, the holder 220, the printed circuit board 410, and the elastic members 210 and 210a can be commonly applied to the linear vibrators 500, 600, 700, 800, 900, 1000, and 1100 according to the first to seventh exemplary embodiments and are not limited to the exemplary embodiments.

On the basis of the exemplary embodiments, the plurality of magnets 310, 320, and 320a disposed in the fixing unit 100 are configured to have the same poles face each other, such that magnetic force lines among the magnets 310, 320, and 320a are dispersed outwardly in a radial direction, as a result, it is possible to maximize magnetic efficiency.

Accordingly, since it is possible to maximize the intensity of electromagnetic force to power consumption in the same volume, it is possible to implement stable linear vibration by ensuring the maximum vibration quantity while minimizing space.

As set forth above, according to exemplary embodiments of the present invention, a linear vibrator can maximize magnetic efficiency while minimizing space.

Further, it is possible to ensure the maximum vibration quantity by maximizing the magnetic efficiency and acquire stable linear vibration.

While the present invention has been shown and described in connection with the exemplary embodiments, it will be apparent to those skilled in the art that modifications and variations can be made without departing from the spirit and scope of the invention as defined by the appended claims. For example, although the substrate with the ink passage has been described as the upper substrate and the lower substrate, it is exemplary and one substrate may be used or three or more substrates may be used and various types of substrates may also be used in respects to the type of the substrate. Accordingly, the scope of the present invention will be determined by the appended claims.

What is claimed is:

1. A linear vibrator, comprising:
a fixing unit providing an internal space having a predetermined size;
a plurality of magnets disposed in the internal space of the fixing unit and positioned to have the same poles face each other so as to generate magnetic force;
a vibration unit disposed to face the magnets and including a coil generating electromagnetic force through interaction with the magnets and a vibrating mass body; and
an elastic member joined to the fixing unit and the vibration unit to provide elastic force.

2. The linear vibrator of claim 1, wherein the fixing unit includes a case providing internal space and having an opened lower part and a bracket sealing the internal space of the case and the magnet is joined to each of one surface of the case and one surface of the bracket.

3. The linear vibrator of claim 1, further comprising a plate formed on one surface of at least one of the magnets and allows magnetic flux that flows on the magnet through the coil to smoothly flow.

4. The linear vibrator of claim 3, wherein the upper surface and the lower surface of the plate are joined to surfaces of the magnets, respectively.

5. The linear vibrator of claim 4, wherein the fixing unit includes a case providing internal space and having an opened lower part and a bracket sealing the internal space of the case and the magnet is joined to each of one surface of the case or one surface of the bracket.

6. The linear vibrator of claim 3, wherein the plate is made of a magnetic material.

7. The linear vibrator of claim 1, wherein the vibration unit includes a holder fixing and supporting the coil and the mass body.

8. The linear vibrator of claim 7, wherein the holder is constituted by a cylindrical vertical portion which contacts one surface of each of the coil and the mass body and a horizontal portion which extends inwardly or outwardly in a radial direction on the end of the vertical portion to fix and support the other surface of the coil or the mass body.

9. The linear vibrator of claim 8, wherein the vertical portion is higher than the lower surfaces of the coil and the mass body to form space between the coil and the mass body and an adhesive is filled in the space.

10. The linear vibrator of claim 1, wherein the coil houses a part of an outer peripheral surface of the magnet and a central axis of the coil is the same as a magnetization direction of the magnet.

11. The linear vibrator of claim 1, further comprising a damper joined to one surface of the vibration unit to prevent contact between the vibration unit and the fixing unit due to vibration of the vibration unit.

12. The linear vibrator of claim 1, further comprising a printed circuit board electrically connected with the coil to provide current to the coil and including a power connection terminal formed at one end thereof.

13. The linear vibrator of claim 12, wherein the printed circuit board includes a movement piece that is joined with the coil and vibrates in conjunction with the vibration unit, a fixation piece that includes the power connection terminal and is joined to the fixing unit, and a connection piece that connects the movement piece and the fixation piece with each other and is flexible.

14. The linear vibrator of claim 12, further comprising a damper joined to one surface of the printed circuit board to prevent contact between the vibration unit and the fixing unit due to vibration of the vibration unit.

15. The linear vibrator of claim 1, wherein the coil includes a coil drawing line that extends to the fixing unit for electrical connection with the power connection terminal joined to the fixing unit to connect the power connection terminal in order to apply power from the outside.

16. The linear vibrator of claim 1, further comprising a magnetic fluid disposed on an outer peripheral surface of the magnet to facilitate vertical movement of the vibration unit.

17. The linear vibrator of claim 16, wherein at least one introduction hole through which a laser beam for joining the elastic member and the vibration unit to each other passes is formed on one surface of the fixing unit to allow the magnetic fluid to be disposed on the outer peripheral surface of the magnet.

18. The linear vibrator of claim 1, wherein the elastic member is at least one of a coil spring and a plate spring.

19. A linear vibrator, comprising:
a fixing unit including a case providing internal space and having an opened lower part and a bracket sealing the internal space of the case;
first and second magnets disposed in the internal space of the fixing unit and positioned to have the same poles face each other so as to generate magnetic force and joined to one surface of the case and one surface of the bracket, respectively;
a vibration unit including coils disposed to face the first and second magnets and generating electromagnetic force through interaction with the first and second magnets and a holder fixing and supporting a vibrating mass body; and
an elastic member joined to the fixing unit and the vibration unit to provide elastic force.

20. The linear vibrator of claim 19, further comprising a plate formed on one surface of at least one of the first and second magnets and allows magnetic flux that flows on the first and second magnets through the coil to smoothly flow.

21. The linear vibrator of claim 19, further comprising a magnetic fluid disposed on an outer peripheral surface of the magnet to facilitate vertical movement of the vibration unit.
